(19) United States
(12) Patent Application Publication
(10) Pub. No.: US 2008/0119173 A1
(43) Pub. Date: May 22, 2008

(54) Multimedia Hold Method and Apparatus

(76) Inventor: Hai Duong Nguyen, Plano, TX (US)

Correspondence Address: CONLEY ROSE, P.C., 5601 GRANITE PARKWAY, SUITE 750, PLANO, TX, 75024, US

(21) Appl. No.: 11/561,574

(22) Filed: Nov. 20, 2006

(51) Int. Cl. H04Q 7/00

(52) U.S. Cl. 455/414.1

(57) ABSTRACT

A multimedia hold system is provided. The system is comprised of a first mobile device and a second mobile device operable to communicate with the first mobile device. The system also includes a component such that when the users of the first and second mobile device are communicating and the user of the first mobile device places the communication on hold, the component promotes providing to the second mobile device multimedia designated by the user of the first mobile device.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

When a telephone call is placed, the calling party might place the called party on hold or the called party might place the calling party on hold. As used herein, the term “subscriber” will be used to refer to a party that places another party on hold and the term “holding party” will refer to a party that has been placed on hold or is about to be placed on hold.

### SUMMARY

In one embodiment, a multimedia hold system is provided. The system is comprised of a first mobile device and a second mobile device operable to communicate with the first mobile device. The system also includes a component such that when the users of the first and second mobile device are communicating and the user of the first mobile device places the communication on hold, the component promotes providing to the second mobile device multimedia designated by the user of the first mobile device.

In another embodiment, a method for providing multimedia is provided. The method is comprised of a first caller communicating with a second caller. The method also consists of the first caller placing the second caller on hold. In addition, the method is comprised of the second caller receiving multimedia selected by the first caller.

In still another embodiment, a system for multimedia hold is provided. The system comprises a telecommunications network operable to promote communication between at least a first and second mobile device. The system also comprises a component operable such that when the users of the first and second mobile devices are communicating and the user of the first mobile device places the communication on hold, the component promotes providing to the second mobile device multimedia. These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a system of two parties interacting through a network according to an embodiment of the present disclosure.

FIG. 2 illustrates an embodiment of a multimedia hold screen according to an embodiment of the present disclosure.

FIG. 3 illustrates a system for providing a multimedia hold feature according to an embodiment of the present disclosure.

FIG. 4 illustrates an embodiment of protocols for providing a multimedia hold feature according to an embodiment of the present disclosure.

FIG. 5 illustrates a method for providing a multimedia hold service according to an embodiment of the present disclosure.

FIGS. 6a-6d illustrate a method for providing the multimedia hold feature using specific elements and procedures according to an embodiment of the present disclosure.

FIG. 7 is a diagram of a wireless communications system including a mobile device operable for some of the various embodiments of the disclosure.

FIG. 8 is a block diagram of a mobile device operable for some of the various embodiments of the disclosure.

FIG. 9 is a diagram of a software environment that may be implemented on a mobile device operable for some of the various embodiments of the disclosure.

FIG. 10 illustrates an exemplary general-purpose computer system suitable for implementing the several embodiments of the present disclosure.

### DETAILED DESCRIPTION

It should be understood at the outset that although an exemplary implementation of one embodiment of the present invention is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

In embodiments of the present disclosure, a service is provided that allows a subscriber to the service to provide content to a holding party when the subscriber places the holding party on hold. The subscriber has the capability to specify the content that will be provided. The content can be multimedia content such as video clips, audio clips, advertisements, or other types of content that might include audio portions, video portions, graphical or text portions, combinations of audio, video, graphics or text, and/or other types of media. Any such category of content can be referred to as a genus of multimedia content. It should be understood that the term “video”, as used herein, does not necessarily refer only to images displayed at a high enough frame rate to suggest motion but could also refer to static images, images displayed at a lower frame rate such as in a slide show, or other types of image displays.

A telecommunications operator, such as a wireless communication service provider, might provide this service, which can be referred to as the multimedia hold feature, to a subscriber. Although described in the context of a subscriber subscribing to a service, the teachings of the present disclosure may be used as part of various service offerings, some of which may be standard or subscription services. The present disclosure should not be limited only to embodiments where it is provided as a subscription.

Also, while the present disclosure focuses on a holding party being placed on hold, it should be understood that similar considerations could apply in other situations. For example, multimedia content could be provided in contexts such as call waiting, call park and retrieve, scheduled multimedia conferencing where participants are waiting for the chair person to join a conference, and similar situations. The term ‘hold’ as used herein can refer to any such hold-based feature.

When the subscriber wishes to place a holding party on hold, the subscriber might push a button or activate some other input mechanism on the subscriber's telecommunications device. Activating the input mechanism activates the multimedia hold feature. This causes a variety of multimedia content to appear on the holding party's telecommunications device, some of which the holding party may select from. If the holding party selects an item of the multimedia content, the holding party can view and/or listen to the selected multimedia content. If the subscriber wishes to resume the call while the holding party is viewing the multimedia content, the subscriber can stop the multimedia hold feature. The exchange of voice data between the holding party and the subscriber can then resume.

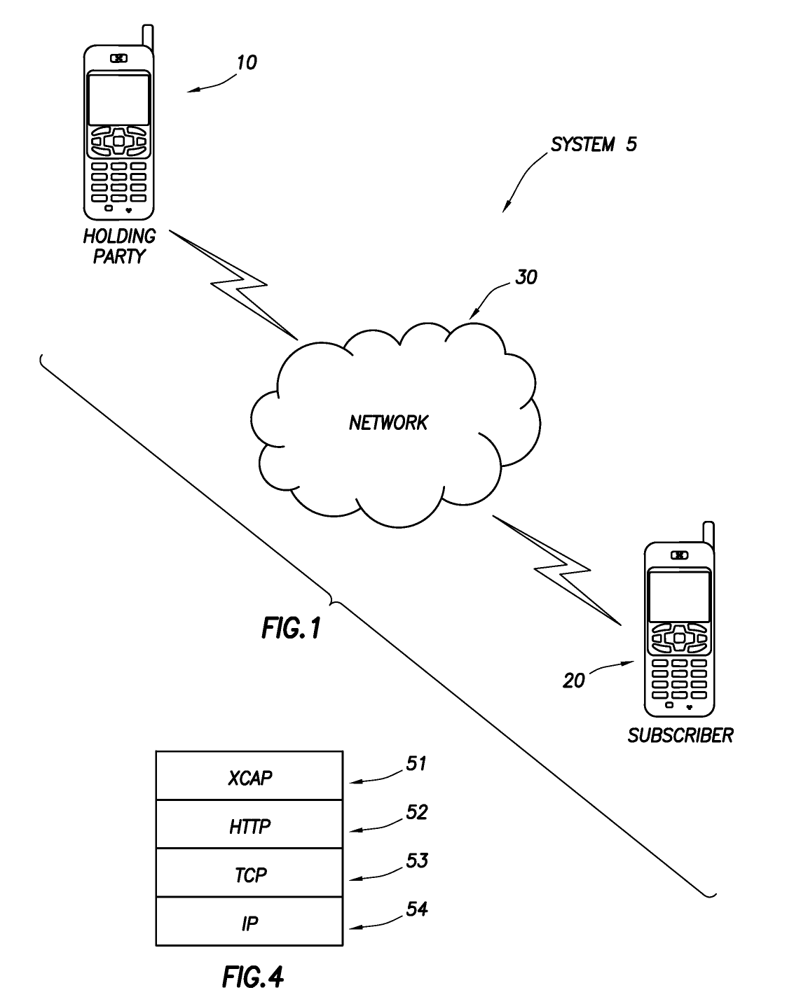

FIG. 1 illustrates an embodiment of a system 5 where a holding party 10 communicates with a subscriber 20 through a network 30. Herein the term “the holding party 10” may sometimes refer to a person or party placed on hold, but may also be used to refer to a device used by such a person or party. Similarly, herein the term “the subscriber 20” may sometimes refer to a person or party placing another person or party on hold, but may also be used to refer to a device used to place another person or party on hold. The holding party 10 and the subscriber 20 may be SIP (Session Initiation Protocol)-enabled 3G (3rd generation) wireless mobile telephones, SIP-enabled landlines, or SIP-enabled soft phones on a PC in some embodiments. The holding party 10 and the subscriber 20 can also be standard mobile handsets as are well-known in the art. Additionally, the holding party 10 and the subscriber 20 may be personal digital assistants (PDAs), portable computers, such as laptop, notebook, and tablet computers, or other mobile communication or computing systems, and the like. Any such device might be referred to as a mobile device. In still other embodiments, the holding party 10 and the subscriber 20 may also be computers, such as desktop, workstation, and kiosk computers. In addition to these embodiments, the holding party 10 and the subscriber 20 may both be the same type of system, or may be combinations of any of the aforementioned systems. It is assumed that any device on which the multimedia hold feature is deployed will have a display capable of displaying multimedia content.

The network 30 may be one or more components of a telecommunications network needed to invoke and carry out the call made between the holding party 10 and the subscriber 20. The network 30 may consist of various functions such as P-CSCF (Proxy Call Session Control Function), S-CSCF (Serving Call Session Control Function), I-CSCF (Interrogating Call Session Control Function), PDF (Policy Decision Function), HSS (Hughes Software Systems), MGCF (Media Gateway Control Function), MG (Media Gateway), and BGCF (Breakout Gateway Control Function).

When a call between the holding party 10 and the subscriber 20 is placed, there may be a desire for the subscriber 20 to place the holding party 10 on hold at some point. When the holding party 10 is placed on hold by the subscriber 20, the subscriber 20 has the option of offering multimedia content to the holding party 10.

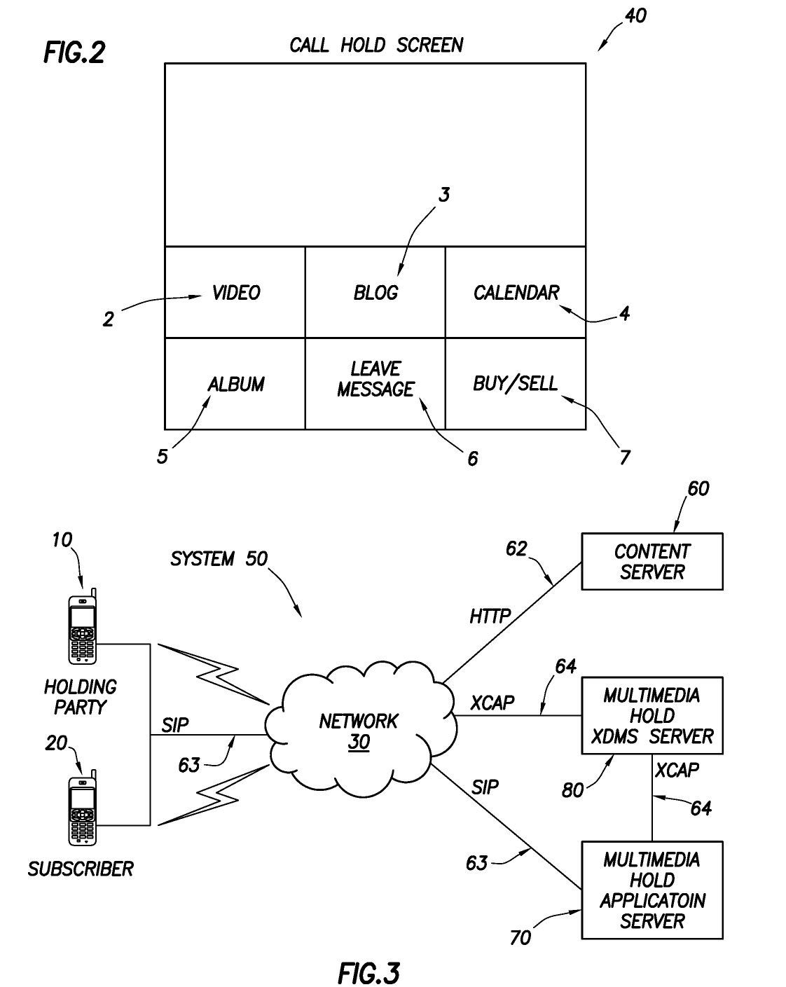

The multimedia content might appear on a call hold screen 40 as shown in FIG. 2. In an embodiment, the subscriber 20 may choose different combinations of multimedia elements to be displayed on the call hold screen 40. In an embodiment, the call hold screen 40 displays a set of tabs, each of which is associated with a type of multimedia content. In FIG. 2, the call hold screen 40 displays an example of different tabs for the holding party 10 to choose from such as a video tab 2, a blog tab 3, a calendar tab 4, an album tab 5, a leave message tab 6, and a buy/sell tab 7. The video tab 2 executes videos offered by the subscriber 20. The blog tab 3 takes the holding party 10 to one or more blogs offered by the subscriber 20. The calendar tab 4 allows the holding party 10 view a schedule. The album tab 5 lets the holding party 10 view pictures of a photo album. The leave message tab 6 allows the holding party 10 to leave a voice message or a video message and disconnect from the call. The buy/sell tab 7 allows the holding party 10 to view an advertisement. Other examples of tabs might exist and are not limited to the ones previously mentioned.

In one example, the subscriber 20 might be a business being called by the holding party 10. When the holding party 10 is placed on hold, the subscriber 20 might send advertisements for the business such as new products, special offers, etc., and the holding party 10 might choose one of the options. If the holding party 10 chooses, for example, to view a video offered by the subscriber 20, the holding party 10 might select the video tab 2 on the call hold screen 40 and start viewing the contents associated with the video tab 2. Choosing one of the other tabs allows the holding party 10 to receive other multimedia content offered by the subscriber 20.

In another example, the subscriber 20 might be a business and the holding party 10 might connect to the business through an IP PBX (Internet Protocol Private Branch Exchange). The business owner might customize a default multimedia call hold screen 40 for all of the users of the PBX. When an employee of the business places the holding party 10 on hold, the holding party 10 will be provided with the multimedia content selected by the business.

Before the multimedia hold feature can be chosen, the subscriber 20 needs to set up and choose the types of multimedia content to be applied for each holding party, group, or the default option. The call hold screen 40 is configurable by the subscriber 20 and can allow different views with the previously mentioned various forms of multimedia. When the holding party 10 calls the subscriber 20, a caller ID feature of the subscriber 20 might detect the identity of the holding party 10 and apply the specific settings for the holding party 10 assigned by the subscriber 20. Alternatively, when the subscriber 20 calls the holding party 10, the identity of the holding party 10 might be obtained from the telephone number entered by the subscriber 20.

For example, the holding party 10 can view the contents of the call hold screen 40 offered by the subscriber 20 and assigned for the holding party 10. The subscriber 20 can customize the layout, contents, and the applications of the call hold screen 40. In an embodiment, the subscriber 20 may have specific versions of the call hold screen 40 assigned for different holding parties. The subscriber 20 may also have specific versions of the call hold screen 40 for different groups of different holding parties. For example, the holding party 10 can be a friend of the subscriber 20 and might be placed in a “friends” group of the subscriber 20. In other embodiments, other labels could be used for the group of friends. In another embodiment, the holding party 10 can be a colleague of the subscriber 20 and might be placed in a group named “colleagues”. A default version of the call hold screen 40 might be provided to holding parties 10 for whom a custom call hold screen 40 has not been designated.

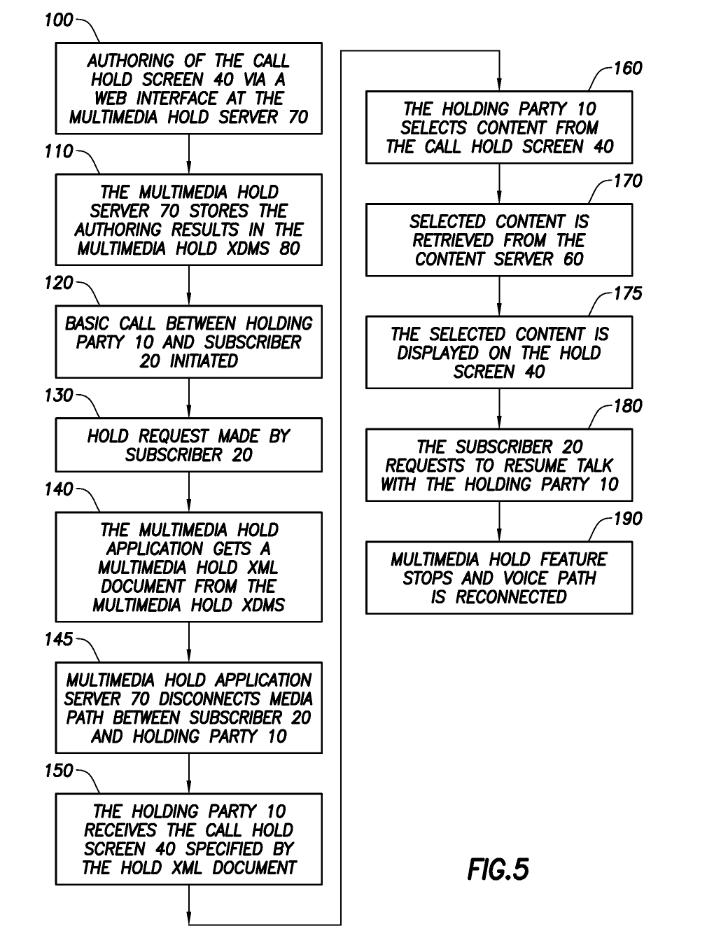

FIG. 3 illustrates an embodiment of a system 50 composed of the network 30, the holding party 10, the subscriber 20, a content server 60, a multimedia hold Extended Markup Language Data Management Server (XDMS) server 80, and a multimedia hold application server 70. The system 50 shows an architecture for providing the multimedia hold feature when a call is being placed amongst the holding party 10 and the subscriber 20. The content server 60 stores different types of multimedia content. In an embodiment, the content server 60 stores content represented by the video tab 2, the blog tab 3, the calendar tab 4, the album tab 5, the leave message tab 6, and the buy/sell tab 7 as seen in the call hold screen 40 in FIG. 2. The content server 60 can also provide a URI (Uniform Resource Identifier) for a web browser on the call hold screen 40. For example, if the holding party 10 had chosen to view a blog associated with the blog tab 3, then that option would have required a web browser which is enabled by the URI.

The multimedia hold application server 70 is a server that may hold the service logic for the multimedia hold feature. This is where the call hold screen 40 may be created. The multimedia hold XDMS 80 is a data management server, which stores documents from the subscriber 20 end. As seen in system 50, the multimedia hold XDMS 80 stores the composed documents of the call hold screen 40, such as XML documents for the subscriber 20. XML documents are used for the multimedia hold XDMS 80 because XML is a commonly used data description language. In other embodiments, the multimedia hold XDMS 80 can hold other documents of various data description languages.

In an embodiment of the system 50, various protocols among the servers and the network are used. For example, in FIG. 3, an HTTP 62 (Hyper Text Transfer Protocol) is seen between the network 30 and the content server 60. SIP (Session Initiation Protocol) 63 is used between the network 30 and the multimedia hold application server 70. SIP 63 is also used between the network 30 and the holding party 10 and the subscriber 20. SIP 63 is appropriate to use since the call between the holding party 10 and the subscriber 20 is being made through the network 30. SIP 63 may run on top of UDP (User Datagram Protocol) and IP (Internet Protocol), which are commonly used protocols in telecommunications networks. In relation to the use of XML documents as discussed previously, SIP 63 is used since this protocol allows for the embedding of XML documents. An XCAP 64 (XML Configuration Access Protocol) is used between the network 30 and the multimedia hold XDMS 80. The XCAP 64 is also used between the multimedia hold XDMS 80 and the multimedia hold application server 70.

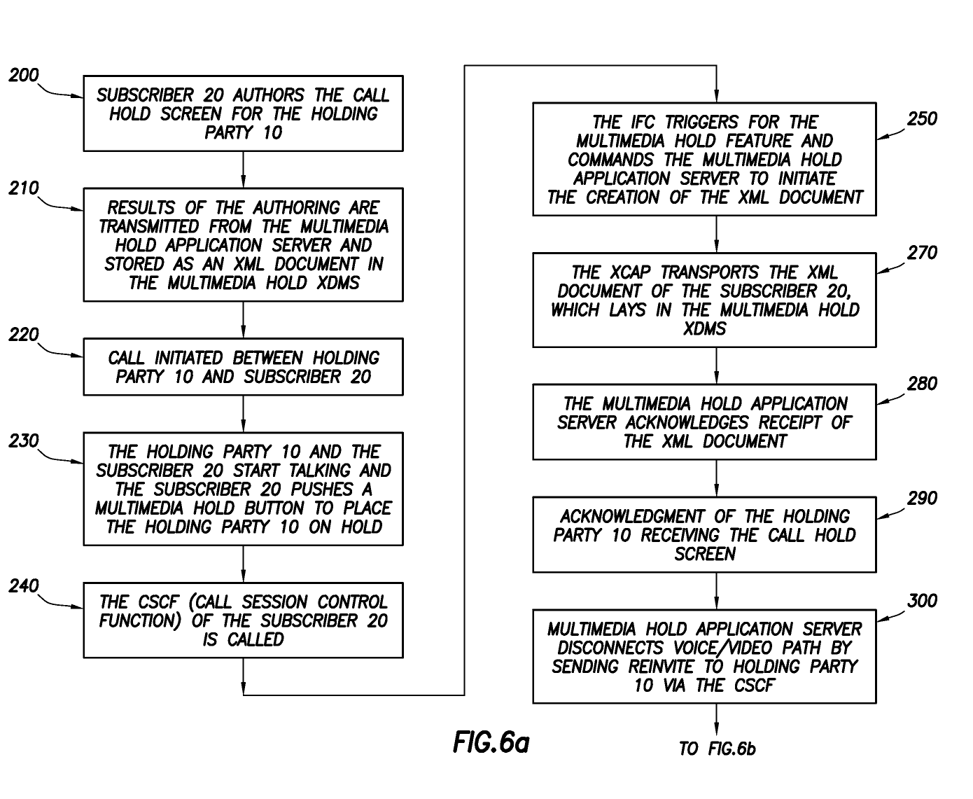

FIG. 4 illustrates one convention of the layers of protocols that may be used as discussed in the previous examples. However, the present disclosure is not limited to these protocols or this convention. In this embodiment, an XCAP layer 51 is on top of an HTTP layer 52 and a TCP (Transmission Control Protocol) layer 53 and an IP (Internet Protocol) layer 54.

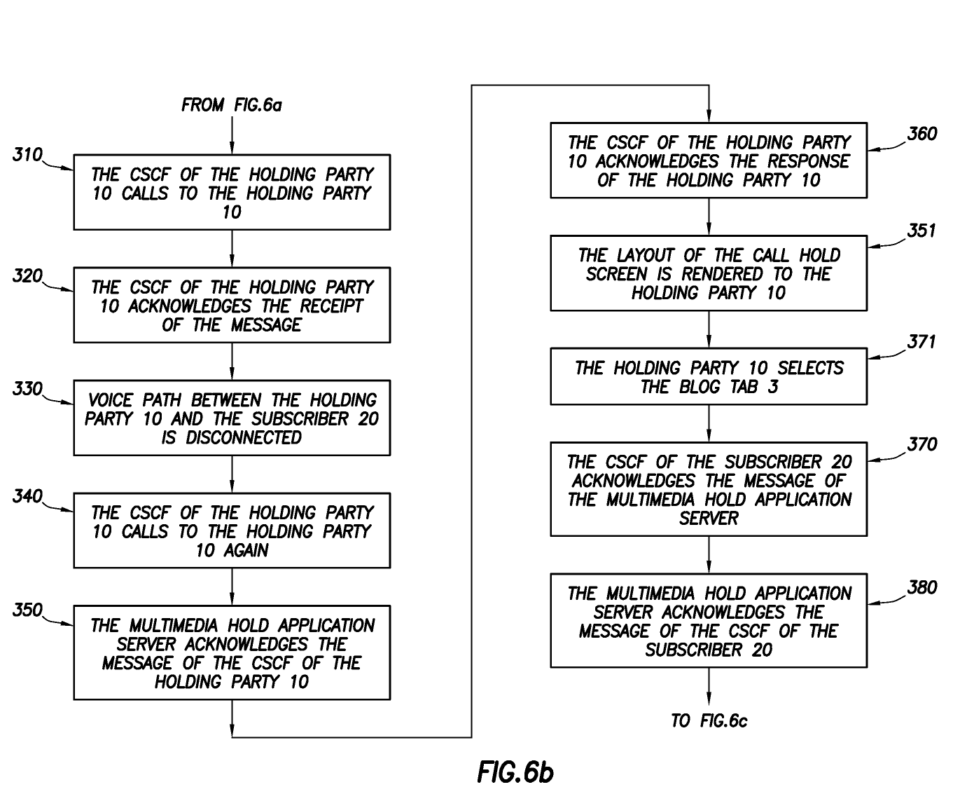

FIG. 5 illustrates a method for providing the multimedia hold feature. In block 100, prior to a call being made between the holding party 10 and the subscriber 20, there needs to be an authoring of the call hold screen 40 via a web interface at the multimedia hold server 70. As discussed earlier, the call hold screen 40 customized for the holding party 10 by the subscriber 20 will take place. In block 110, the multimedia hold server 70 stores the authoring results in the multimedia hold XDMS 80. In block 120, a basic call between the holding party 10 and the subscriber 20 is established. In block 130, there is a hold request made by subscriber 20. This hold request actually takes place through the network 30 and the multimedia hold application server 70.

In block 140, the multimedia hold application server 70 gets a multimedia hold XML document from the multimedia hold XDMS 80. The subscriber's multimedia hold XML document may contain several hold screens 40. Some of the hold screens 40 might be customized for different holding parties 10 and one of the hold screens 40 might be a default hold screen for holding parties 10 for whom one of the customized hold screens 40 has not been created. For example, the hold screen 40 for holding party A might include the video tab 2 and the blog tab 3. The hold screen 40 for holding party B might include the calendar tab 4 and the photo album tab 5. The default hold screen 40 might include only the video tab 2. When the holding party 10 is placed on hold, the multimedia hold application might search the subscriber's multimedia hold XML document using the holding party's URI to determine if one of the customized hold screens 40 for the holding party 10 is present. If one of the customized hold screens 40 is found, it is sent to the holding party 10. If one of the customized hold screens 40 is not found, the default hold screen 40 is sent to the holding party 10.

In box 145, the multimedia hold application server 70 disconnects the media path between the subscriber 20 and the holding party 10. In block 150, the holding party 10 receives the call hold screen 40 specified by the multimedia hold XML document. In block 160, the holding party 10 selects content from the call hold screen 40. In block 170, the selected content is retrieved from the content server 60. In block 175, the selected content is displayed on the call hold screen 40. In block 180, the subscriber 20 requests to resume talk with the holding party 10. This action takes place between the multimedia hold application server 70 and the network 30. In block 190, the multimedia hold server 70 stops the multimedia hold feature and reconnects the voice path between the subscriber 20 and the holding party 10.

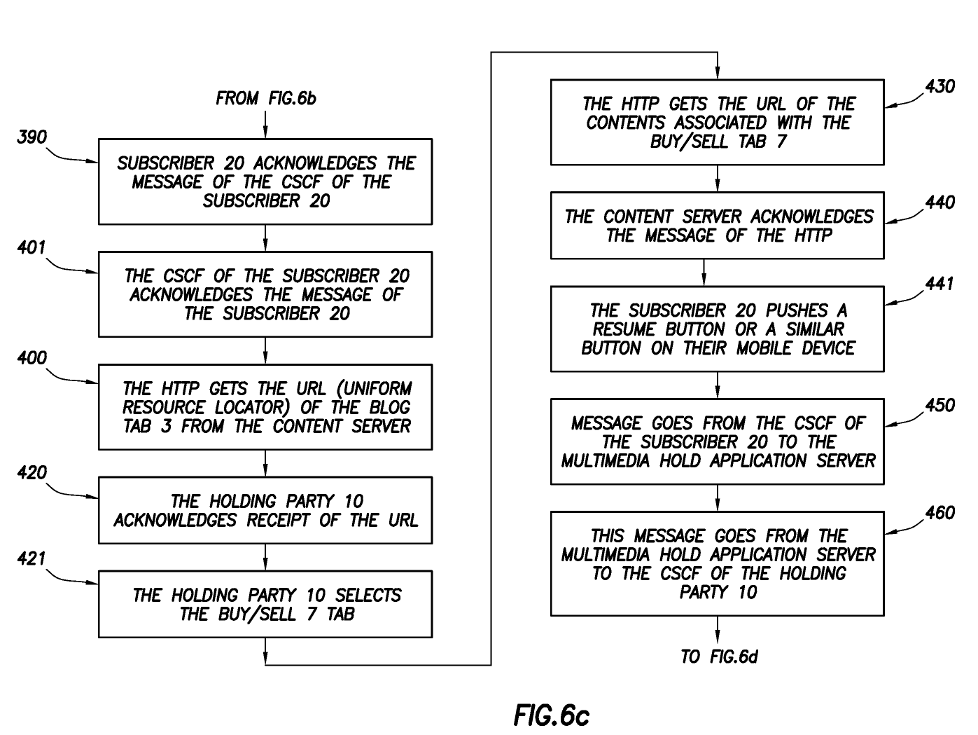

FIGS. 6a-6d illustrate an embodiment of a multimedia hold call flow using SIP, HTTP, and XCAP signaling for when the multimedia hold feature is used. It should be understood that this embodiment is provided only as an example of a set of transactions that might occur in one set of circumstances. All of the steps described in FIGS. 6a-6d do not necessarily need to occur and the steps do not necessarily need to occur in the order stated.

In block 200, the subscriber 20 authors the call hold screen for the holding party 10. This is done using a web interface or client interface and happens between the subscriber 20 and the multimedia hold application server. In this embodiment, the default screen is set to display: the blog tab 3, a music tab 8, and the leave message tab 6. Also for this embodiment, the customized call hold screen 40 for the holding party 10 is set to display: the blog tab 3, the buy/sell tab 7, and the leave message tab 6. In this embodiment, there is another holding party that the subscriber 20 puts on hold while connected with the holding party 10 simultaneously. For this example, a call hold screen for the other holding party shows solely an advertisement.

In block 210, the results of the authoring are transmitted from the multimedia hold application server and stored as an XML document in the multimedia hold XDMS. Block 220 shows a call being initiated between the two parties, the holding party 10 and the subscriber 20. In block 230, the holding party 10 and the subscriber 20 start talking and the subscriber 20 pushes a multimedia hold button to place the holding party 10 on hold. In block 240, when the subscriber 20 puts the holding party 10 on hold, the CSCF (call session control function) of the subscriber 20 is called. When this happens, in block 250, the IFC triggers for the multimedia hold feature and commands the multimedia hold application server to initiate the creation of the XML document.

In block 270, the XCAP transports the XML document of the subscriber 20, which resides on the multimedia hold XDMS. In block 280, the multimedia hold application server acknowledges receipt of the XML document. In block 290, there is an acknowledgment of the holding party 10 receiving the call hold screen. In block 300, the multimedia hold application server disconnects the voice/video path by sending a REINVITE message to the holding party 10 via the CSCF. In block 310, the CSCF of the holding party 10 calls to the holding party 10. In block 320, then the CSCF of the holding party 10 acknowledges the receipt of the message. In block 330, the voice path between the holding party 10 and the subscriber 20 is disconnected. In block 340, the CSCF of the holding party 10 calls to the holding party 10 again.

In block 350, the multimedia hold application server acknowledges the message of the CSCF of the holding party 10. In block 360, the CSCF of the holding party 10 acknowledges the response of the holding party 10. In block 351, the layout of the call hold screen is rendered to the holding party 10. In block 371, the holding party 10 selects the blog tab 3. In blocks 370 and 380, the CSCF of the subscriber 20 acknowledges the message of the multimedia hold application server and the multimedia hold application server acknowledges the message of the CSCF of the subscriber 20. In blocks 390 and 401, the subscriber 20 acknowledges the message of the CSCF of the subscriber 20 and the CSCF of the subscriber 20 acknowledges the message of the subscriber 20.

In block 400, the HTTP gets the URL (Uniform Resource Locator) of the blog tab 3 from the content server. In block 420, the holding party 10 acknowledges receipt of the URL. In block 421, the holding party 10 selects the buy/sell 7 tab. In block 430, the HTTP gets the URL of the contents associated with the buy/sell tab 7, which are stored in the content server. In block 440, the content server acknowledges the message of the HTTP. Blocks 350, 360, 370, 380, 390, and 401 may execute in parallel with blocks 400, 420, 421, 430, and 440.

In block 441, the subscriber 20 pushes a resume button or a similar button on the mobile device of the subscriber 20. In blocks 450 and 460, a message indicating that the resume button was pushed goes from the CSCF of the subscriber 20 to the multimedia hold application server. In blocks 460 and 480, this message goes from the multimedia hold application server to the CSCF of the holding party 10 and on towards the mobile device of the holding party 10. In block 490, the CSCF of the holding party 10 acknowledges the message. In block 491, the call hold screen displayed on the mobile device of the holding party 10 clears.

In block 500, the mobile device of the holding party 10 acknowledges the message from the CSCF of the holding party 10. In blocks 501 and 521, the multimedia hold application server 70 acknowledges the CSCF of the holding party 10 as does the CSCF of the holding party 10 to the multimedia hold application server. In blocks 531 and 540, the CSCF of the subscriber 20 acknowledges the message from the multimedia hold application server as the multimedia hold application server 70 reciprocates this receipt from the CSCF of the subscriber 20. In blocks 550 and 560, the mobile phone of the subscriber 20 acknowledges the message as the CSCF of the subscriber 20 acknowledges receipt of the message from the subscriber 20. Finally, in block 570, the voice path is resumed between the holding party 10 and the subscriber 20.

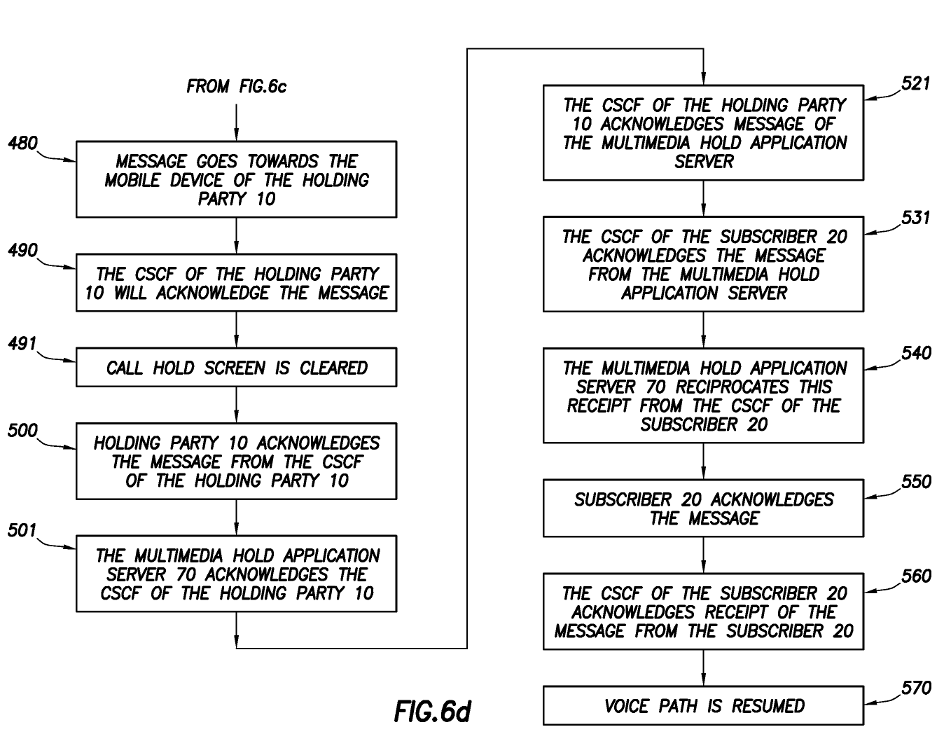

FIG. 7 shows a wireless communications system including a mobile device 25 that might be used by the holding party 10 and/or the subscriber 20. The mobile device 25 is operable for implementing aspects of the disclosure, but the disclosure should not be limited to these implementations. Though illustrated as a mobile phone, the mobile device 25 may take various forms including a wireless handset, a pager, a personal digital assistant (PDA), a portable computer, a tablet computer, or a laptop computer. Many suitable mobile devices combine some or all of these functions. In some embodiments of the disclosure, the mobile device 25 is not a general purpose computing device like a portable, laptop or tablet computer, but rather is a special-purpose communications device such as a mobile phone, wireless handset, pager, or PDA.

The mobile device 25 includes a display 102 and a touch-sensitive surface or keys 404 for input by a user. The mobile device 25 may present options for the user to select, controls for the user to actuate, and/or cursors or other indicators for the user to direct. The mobile device 25 may further accept data entry from the user, including numbers to dial or various parameter values for configuring the operation of the mobile device 25. The mobile device 25 may further execute one or more software or firmware applications in response to user commands. These applications may configure the mobile device 25 to perform various customized functions in response to user interaction.

Among the various applications executable by the mobile device 25 are a web browser, which enables the display 102 to show a web page. The web page is obtained via wireless communications with a cell tower 406, a wireless network access node, or any other wireless communication network or system. The cell tower 406 (or wireless network access node) is coupled to a wired network 408, such as the Internet. Via the wireless link and the wired network, the mobile device 25 has access to information on various servers, such as a server 410. The server 410 may provide content that may be shown on the display 102 and may be equivalent to any or all of the servers 60, 70, and/or 80 of FIG. 3.

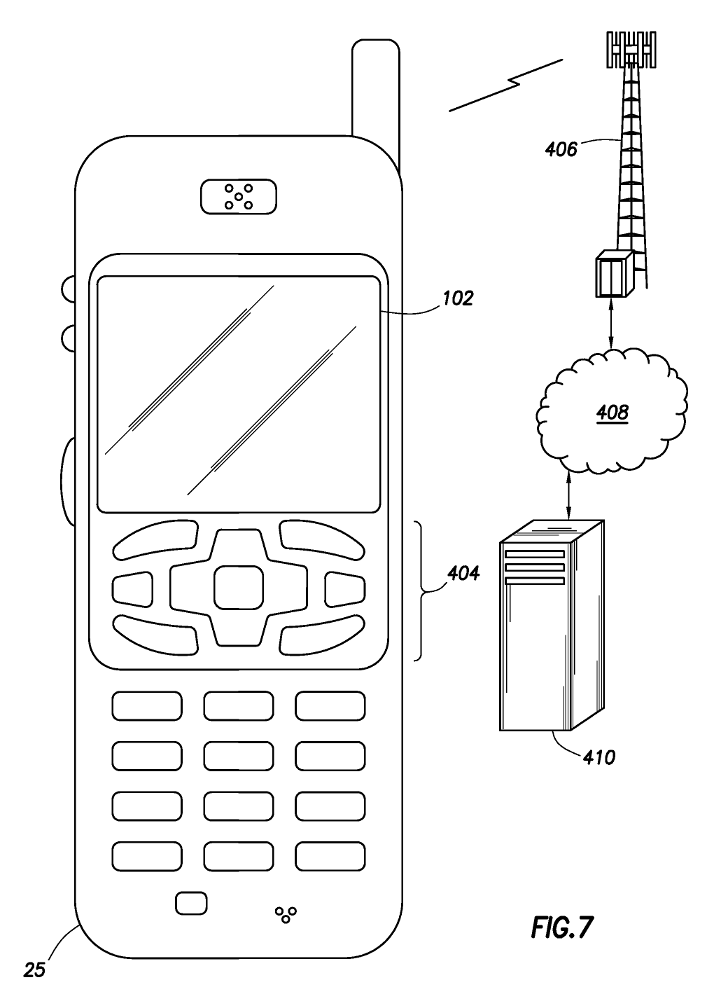

FIG. 8 shows a block diagram of the mobile device 25. The mobile device 25 includes a digital signal processor (DSP) 502 and a memory 504. As shown, the mobile device 25 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538.

The DSP 502 or some other form of controller or central processing unit operates to control the various components of the mobile device 25 in accordance with embedded software or firmware stored in memory 504. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the mobile device 25 to send and receive information from a cellular network or some other available wireless communications network. The RF transceiver 508 provides frequency shifting, converting received RF signals to baseband and converting baseband transmit signals to RF. The analog baseband processing unit 510 may provide channel equalization and signal demodulation to extract information from received signals, may modulate information to create transmit signals, and may provide analog filtering for audio signals. To that end, the analog baseband processing unit 510 may have ports for connecting to the built-in microphone 512 and the earpiece speaker 514 that enable the mobile device 25 to be used as a cell phone. The analog baseband processing unit 510 may further include a port for connecting to a headset or other hands-free microphone and speaker configuration.

The DSP 502 may send and receive digital communications with a wireless network via the analog baseband processing unit 510. In some embodiments, these digital communications may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the infrared port 524. The USB interface 522 may enable the mobile device 25 to function as a peripheral device to exchange information with a personal computer or other computer system. The infrared port 524 and other optional ports such as a Bluetooth interface or an IEEE 802.11 compliant wireless interface may enable the mobile device 25 to communicate wirelessly with other nearby handsets and/or wireless base stations.

The input/output interface 518 may further connect the DSP 502 to the vibrator 526 that, when triggered, causes the mobile device 25 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the mobile device 25. Another input mechanism may be the touch screen LCD 530, which may also display text and/or graphics to the user. The touch screen LCD controller 532 couples the DSP 502 to the touch screen LCD 530.

The CCD camera 534 enables the mobile device 25 to take digital pictures. The DSP 502 communicates with the CCD camera 534 via the camera controller 536. The GPS sensor 538 is coupled to the DSP 502 to decode global positioning system signals, thereby enabling the mobile device 25 to determine its position. Various other peripherals may also be included to provide additional functions, e.g., radio and television reception.

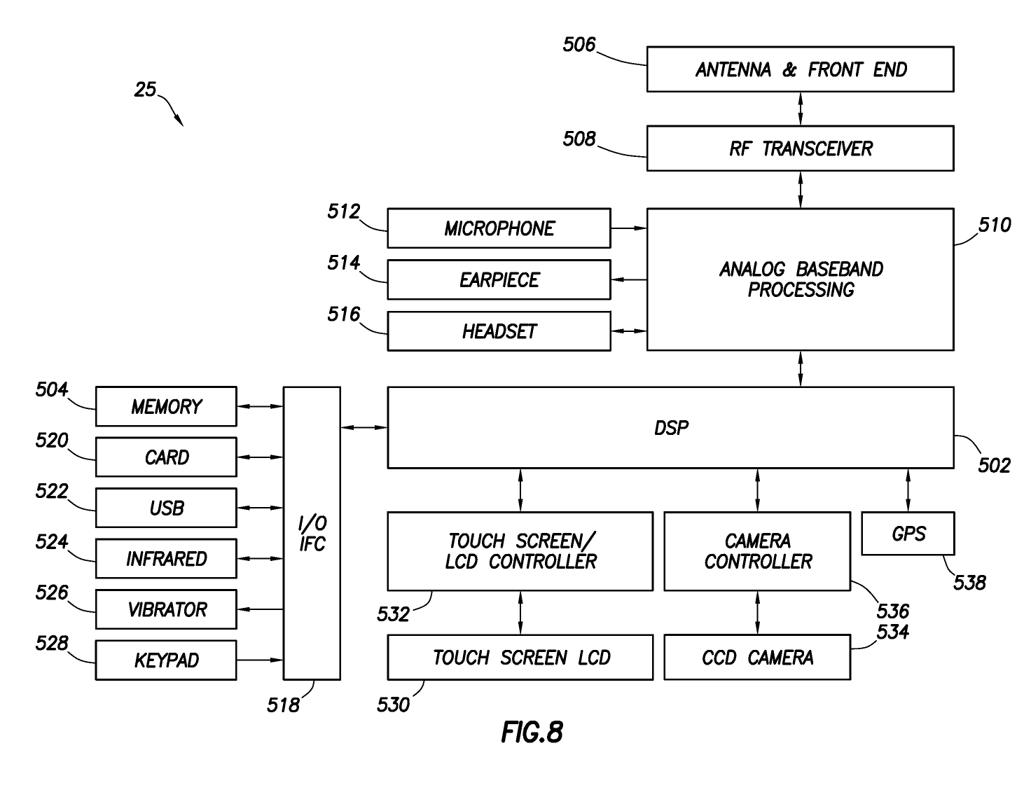

FIG. 9 illustrates a software environment 602 that may be implemented by the DSP 502. The DSP 502 executes operating system drivers 604 that provide a platform from which the rest of the software operates. The operating system drivers 604 provide drivers for the handset hardware with standardized interfaces that are accessible to application software. The operating system drivers 604 include application management services (“AMS”) 606 that transfer control between applications running on the mobile device 25. Also shown in FIG. 9 are a web browser application 608, a media player application 610, and Java applets 612. The web browser application 608 configures the mobile device 25 to operate as a web browser, allowing a user to enter information into forms and select links to retrieve and view web pages. The media player application 610 configures the mobile device 25 to retrieve and play audio or audiovisual media. The Java applets 612 configure the mobile device 25 to provide games, utilities, and other functionality. A component 614 might provide a portion of the functionality that promotes the multimedia hold function.

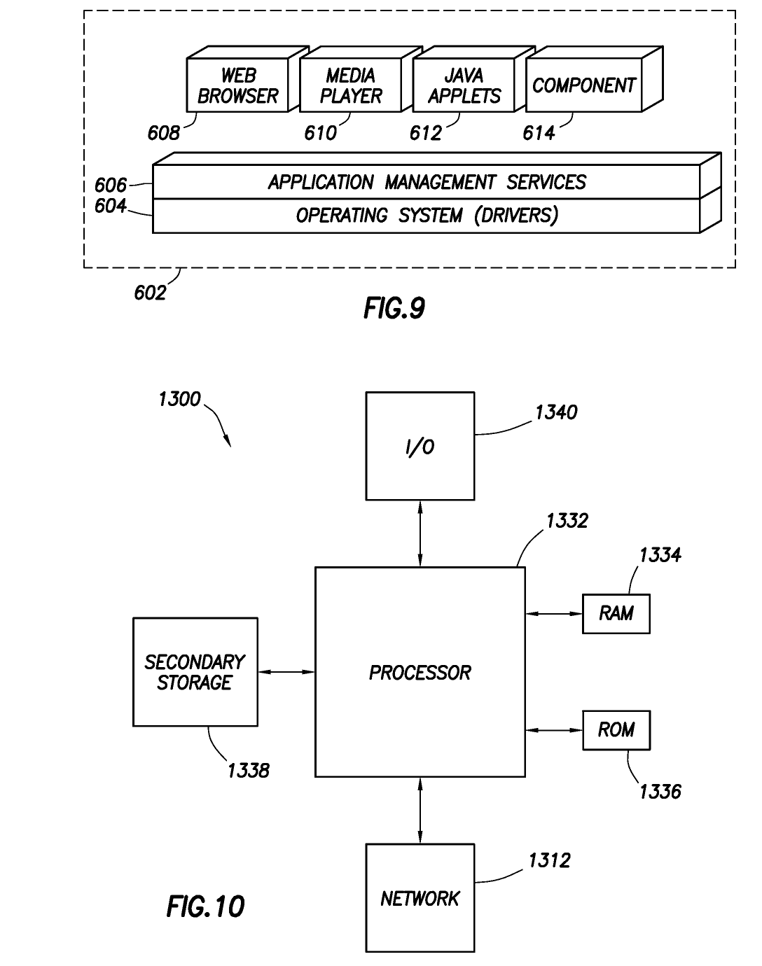

The servers 60, 70, 80, and 410 described above may be implemented on any general-purpose computer with sufficient processing power, memory resources, and network throughput capability to handle the necessary workload placed upon it. FIG. 10 illustrates a typical, general-purpose computer system 1300 suitable for implementing one or more embodiments disclosed herein, including operating as the server 60, the server 70, the server 80, and/or the server 410. The computer system 1300 includes a processor 1332 (which may be referred to as a central processor unit or CPU) that is in communication with memory devices including secondary storage 1338, read only memory (ROM) 1336, random access memory (RAM) 1334, input/output (I/O) devices 1340, and network connectivity devices 1312. The processor 1332 may be implemented as one or more CPU chips.

The secondary storage 1338 is typically comprised of one or more disk drives or tape drives and is used for non-volatile storage of data and as an overflow data storage device if the RAM 1334 is not large enough to hold all working data. Secondary storage 1338 may be used to store programs which are loaded into the RAM 1334 when such programs are selected for execution. The ROM 1336 is used to store instructions and perhaps data which are read during program execution. The ROM 1336 is a non-volatile memory device which typically has a small memory capacity relative to the larger memory capacity of the secondary storage 1338. The RAM 1334 is used to store volatile data and perhaps to store instructions. Access to both ROM 1336 and RAM 1334 is typically faster than to secondary storage 1338.

I/O devices 1340 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 1312 may take the form of modems, modem banks, ethernet cards, universal serial bus (USB) interface cards, serial interfaces, token ring cards, fiber distributed data interface (FDDI) cards, wireless local area network (WLAN) cards, ultra-wideband (UWB) cards, radio transceiver cards such as code division multiple access (CDMA) and/or global system for mobile communications (GSM) radio transceiver cards, and other well-known network devices. These network connectivity devices 1312 may enable the processor 1332 to communicate with the Internet or one or more intranets. With such a network connection, it is contemplated that the processor 1332 might receive information from the network, or might output information to the network in the course of performing the above-described method steps. Such information, which is often represented as a sequence of instructions to be executed using the processor 1332, may be received from and outputted to the network, for example, in the form of a computer data signal embodied in a carrier wave.

Such information, which may include data or instructions to be executed using the processor 1332 for example, may be received from and outputted to the network, for example, in the form of a computer data baseband signal or signal embodied in a carrier wave. The baseband signal or signal embodied in the carrier wave generated by the network connectivity devices 1312 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 1332 executes instructions, codes, computer programs, and scripts which it accesses from hard disk, floppy disk, optical disk (these various disk-based systems may all be considered secondary storage 1338), ROM 1336, RAM 1334, or the network connectivity devices 1312.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A multimedia hold system, comprising:
a first mobile device;
a second mobile device operable to communicate with the first mobile device; and
a component such that when the users of the first and second mobile device are communicating and the user of the first mobile device places the communication on hold, the component promotes providing to the second mobile device multimedia designated by the user of the first mobile device.

2. The system of claim 1, wherein multimedia includes one of video data and audio-video data, a graphical user interface including interactive menus.

3. The system of claim 1, wherein multimedia includes a graphical user interface including interactive menus from which the user of the second mobile device selects.

4. The system of claim 1, wherein the multimedia is such that the user of the second device can interact with the multimedia.

5. The system of claim 4, wherein the user of the second mobile device selects multimedia to interact with including one of: videos, photos, music, other audios, games to play.

6. The system of claim 1 wherein the first and second mobile devices are selected from a group consisting of: mobile handsets and personal digital assistants (PDAs).

7. The system of claim 1 wherein the first and second mobile devices are selected from a group consisting of: laptop computers, desktop computers, workstation computers, personal computers, and portable computers.

8. A method for providing multimedia, comprising:
a first caller communicating with a second caller;
the first caller placing the second caller on hold; and
the second caller receiving multimedia selected by the first caller.

9. The method of claim 8, further comprising:
providing a graphical user interface including one or more options selectable by the second caller; and
the second caller selecting one of the options from the graphical user interface.

10. The method of claim 9, further comprising providing the second caller with information based on the selection.

11. The method of claim 10, wherein the information is one of photos, videos, audios, and other multimedia.

12. The method of claim 9, further comprising selecting from the options to leave a message for the first caller, and wherein the message is one of a text message, a voice message, and a audio-video message.

13. The method of claim 9, further comprising the second caller selecting to browse one of: the Internet and another network while on hold.

14. The method of claim 8, wherein the multimedia is further defined as multimedia advertisements.

15. A system for multimedia hold, comprising:
a telecommunications network operable to promote communication between at least a first and second mobile device; and
a component operable such that when users of the first and second mobile devices are communicating and the user of the first mobile device places the communication on hold, the component promotes providing to the second mobile device multimedia.

16. The system of claim 15, wherein the multimedia provided to the second mobile device is designated by the user of the first mobile device.

17. The system of claim 15, wherein the multimedia is designated by one of a telecommunications service provider and an advertiser.

18. The system of claim 15, wherein the multimedia includes a graphical user interface displayed on a display of the second mobile device and operable for the user of the second mobile device to make selections.

19. The system of claim 18, wherein the selections selectable by the user of the second mobile device include one or more of: games playable by the user, photo albums viewable by the user, videos viewable by the user, advertisements viewable by the users, text and graphics viewable by the user, and a leave message option whereby the user leaves a message.

20. The system of claim 15, wherein the multimedia is further defined as advertisements, audio-video, video, photos, text with one or more of audio and video, text only.
